(19) United States
(12) Patent Application Publication
(10) Pub. No.: US 2009/0208831 A1
(43) Pub. Date: Aug. 20, 2009

(54) DEVICE HAVING ELECTRODE GROUP

(75) Inventor: Kazuyuki Tanino, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/372,845

(22) Filed: Feb. 18, 2009

(30) Foreign Application Priority Data
Feb. 20, 2008 (JP) 2008-039000

(51) Int. Cl. H01M 6/46

(52) U.S. Cl. 429/127

(57) ABSTRACT

There is provided a device with which an optional voltage and an optional capacity may be obtained in one device. A device wherein a plurality of electrode groups each comprising a positive electrode sheet having an electrode tab, a negative electrode sheet having an electrode tab, and a separator disposed so as to insulate the positive electrode sheet from the negative electrode sheet, are included in a single vessel. The device being used as a storage device, and the device being used as a nonaqueous electrolytic solution secondary battery.

### BACKGROUND OF THE INVENTION

1. Field of the Invention

The present invention relates to a device having an electrode group.

2. Description of the Related Art

A device having an electrode group is mainly used as a storage device such as a battery, particularly, a secondary battery. A battery having one electrode group produced by winding or laminating a positive electrode sheet, a negative electrode sheet and a separator is known as the device (refer to Japanese Unexamined Patent Publication No. 11-250935).

### SUMMARY OF THE INVENTION

With regard to the conventional device as described above, the capacity thereof is adjusted by the number of turns or the number of laminations of the electrode group. However, in the case of changing the capacity in such a device, it is necessary to obtain the device by separately preparing electrode groups with different number of turns or different number of laminations in accordance with the capacity. The voltage of the device does not depend on the number of turns or the number of laminations, and it is occasionally necessary to connect and combine a plurality of devices in series for obtaining an optional voltage. In this case, a plurality of devices are necessary and each of the devices is independent, so that temperature difference is caused between the devices and the discharge state of the devices varies with this temperature difference, and consequently it is difficult to sufficiently bring out the performance of the devices. The use of plural devices necessarily causes dead space except the devices themselves and it is difficult to say that the space is effectively utilized.

In this connection, the present invention is intended to provide a device with which an optional voltage and an optional capacity may be obtained in one device.

The present invention provides the following (1) to (11),

(1) a device wherein a plurality of electrode groups each comprising a positive electrode sheet having an electrode tab, a negative electrode sheet having an electrode tab, and a separator disposed so as to insulate the positive electrode sheet from the negative electrode sheet, are included in a single vessel;

(2) the device according to (1), in which a plurality of electrode groups each obtained by winding a positive electrode sheet having an electrode tab, a negative electrode sheet having an electrode tab, and a separator disposed so as to insulate the positive electrode sheet from the negative electrode sheet, are included in a single vessel;

(3) the device according to (1) or (2), in which the vessel is made of a laminated film;

(4) the device according to any one of (1) to (3), in which all of the electrode tabs are taken outside the vessel;

(5) the device according to any one of (1) to (3), in which at least two of the electrode groups among the plurality of electrode groups are connected in series or in parallel inside the vessel by connection of the electrode tab of each of the electrode groups;

(6) the device according to any one of (1) to (5), being used as a storage device;

(7) the device according to any one of (1) to (6), further including a material capable of ionic conduction in the vessel, in which the material is shared among the plurality of electrode groups;

(8) the device according to (7), in which the material is a material capable of conduction of a lithium ion and/or a sodium ion;

(9) the device according to (7) or (8), being used as a battery;

(10) the device according to any one of (7) to (9); in which the material is a nonaqueous electrolytic solution; and

(11) the device according to any one of (7) to (10), being used as a nonaqueous electrolytic solution secondary battery.

The present invention may provide a device with which an optional voltage and an optional capacity may be obtained in one device. In particular, in the case of use as a storage device, a storage device with an optional voltage and an optional capacity may be obtained without combining a plurality of storage devices. In addition, in the case of use as a battery, temperature difference in the device may be rendered smaller. Thus, the performance of the battery may be sufficiently brought out. Also, the present invention may save space as compared with the case of using a plurality of devices. Thus, the space may be effectively utilized. In addition, in the device of the present invention, the electrode group is easily taken out of the vessel and may be reused, so that a flexible use of the device becomes possible.

### BRIEF DESCRIPTION OF THE DRAWINGS

FIG. 1 is a schematic view showing an electrode group.

FIG. 2 is a schematic view showing a laminate battery of examples of the present invention.

FIG. 3 is a cross-sectional schematic view showing a laminate battery of examples of the present invention.

### EXPLANATION OF THE SYMBOLS

1 positive electrode sheet
2 negative electrode sheet
3 separator
4 separator
5 electrode tab
6 electrode group
7 laminated film
8 laminated battery
9 electrode group A
10 electrode group B

### DETAILED DESCRIPTION OF THE PREFERRED EMBODIMENTS

The device according to the present invention is a plurality of electrode groups each comprising a positive electrode sheet having an electrode tab, a negative electrode sheet having an electrode tab, and a separator disposed so as to insulate the positive electrode sheet, from the negative electrode sheet are included in a single vessel. In the present invention, the electrode group means a unit comprising a positive electrode sheet having an electrode tab, a negative electrode sheet having an electrode tab, and a separator disposed so as to insulate the positive electrode sheet from the negative electrode sheet.

In the present invention, examples of the device include a storage device, specifically, a battery such as a nonaqueous electrolytic solution secondary battery, a condenser and a capacitor.

The device of the present invention is hereinafter described by using an example of a nonaqueous electrolytic solution secondary battery such as a lithium secondary battery, but is not limited thereto.

The positive electrode sheet to be ordinarily used is a sheet in which a positive electrode mixture containing a positive electrode material capable of being doped and dedoped with a lithium ion, a conductive material, and a binding agent is supported on a positive electrode current collector. Specifically, the positive electrode sheet to be used is a sheet in which the positive electrode material contains a complex oxide capable of being doped and dedoped with a lithium ion, the conductive material contains a carbonaceous material, and the binding agent contains a thermoplastic resin.

Examples of the complex oxide capable of being doped and dedoped with a lithium ion include a lithium complex oxide containing Li and at least one transition metal such as Mn, Fe, Co and Ni. Preferable examples of the lithium complex oxide include complex oxides represented by the following formulae (1) and (2).

LiₓNi_{1-y}M_{y}O₂ (1)

(In the formula, the ranges of x and y are 0.9≦x≦1.2 and 0≦y≦0.3 respectively, and M denotes one or more element selected from Co, Fe and Mn.)

It is preferable to use the complex oxide represented by the formula (1) as the lithium complex oxide since it allows the device of the present invention to be particularly used as a nonaqueous electrolytic solution secondary battery appropriate for usages for which a large capacity is required, such as portable telephones and notebook computers. In the formula (1), the range of y is preferably 0.01≦y≦0.2, more preferably 0.02≦y≦0.18. In order to further improve the capacity of a nonaqueous electrolytic solution secondary battery, N is preferably Co in the formula (1).

LiₓNi_{1-z}M_{z}O₂ (2)

(In the formula, the ranges of x and z are 0.9≦z≦1.2 and 0.3≦z≦0.9 respectively, and M denotes at least one element selected from Co, Fe and Mn.)

It is preferable to use the complex oxide represented by the formula (2) as the lithium complex oxide since it allows the device of the present invention to be used as a small-sized power source for electric tools and a nonaqueous electrolytic solution secondary battery appropriate for usages for which high output is required, such as electric cars and hybrid cars. In the formula (2), M is preferably two or more elements selected from Co, Fe and Mn, and the range of z is preferably 0.4≦y≦0.8, more preferably 0.5≦y≦0.7.

In the formulae (1) and (2), the range of x is preferably 0.95≦x≦1.1 from the viewpoint of cyclability in the case where the device is used as a nonaqueous electrolytic solution secondary battery.

Also, specific examples of the lithium complex oxide except the complex oxides represented by the formulae (1) and (2) include lithium cobaltate (LiCoO₂) and lithium manganese spinel (LiMn₂O₄).

In the lithium complex oxide, a part of constituent elements of the oxide may be substituted with various elements in accordance with the required performance of the device; examples of the substitutional element include Ti, V, Cr, Cu, Ag, Mg, Al, Ga, In, Sn, and an element comprising a combination thereof.

In the present invention, the complex oxide capable of being doped and dedoped with a lithium ion such as the lithium complex oxide may be used as the positive electrode material singly or by performing surface treatment for covering with a compound containing elements such as Al, B, Ga and In.

Al, Ni and stainless steel may be used as the positive electrode current collector, and Al is preferable in view of being easily processed into a thin film and being inexpensive. Examples of a method for making the current collector support the positive electrode mixture containing the positive electrode material, the conductive material, and the binding agent include a method for pressure molding or a method for making into a paste by using an organic solvent to apply the paste on both sides or one side of the current collector and bond under pressure by pressing after the paste is dried. In the case of applying the paste on the current collector, a paste comprising the positive electrode material, the conductive material, the binding agent, and an organic solvent is used. Examples of a method for applying include a slit-die coating method, a screen coating method, a curtain coating method, a knife coating method, a gravure coating method and an electrostatic spray coating method.

Examples of the organic solvent include amine solvents such as N,N-dimethylaminopropylamine and diethylenetriamine, ether solvents such as tetrahydrofuran, ketone solvents such as methyl ethyl ketone, ester solvents such as methyl acetate, and amide solvents such as dimethylacetamide and N-methyl-2-pyrrolidone (NMP).

Examples of the binding agent include a thermoplastic resin; specific examples thereof include fluororesins such as polyvinylidene fluoride (occasionally referred to as PVDF hereinafter), polytetrafluoroethylene (occasionally referred to as PTFE hereinafter), a tetrafluoroethylene-hexafluoropropylene-vinylidene fluoride copolymer, a hexafluoropropylene-vinylidene fluoride copolymer and a tetrafluoroethylene-perfluorovinyl ether copolymer, and polyolefin resins such as polyethylene and polypropylene. Two kinds or more thereof may be used by mixing them with each other.

Examples of the conductive material include a carbonaceous material; specific examples thereof include natural graphite, artificial graphite, coke, carbon black, acetylene black and a fibrous carbon material (such as carbon nanotubes). Each of them may be used singly as the conductive material, and a composite conductive material such as a mixture of artificial graphite and carbon black may be selected.

A negative electrode material capable of being doped and dedoped with a lithium ion, a lithium metal or a lithium alloy may be used as the negative electrode sheet. In the case of using the negative electrode material capable of being doped and dedoped with a lithium ion, the negative electrode sheet is ordinarily used while a negative electrode mixture containing the negative electrode material is supported on a sheet-like negative electrode current collector. The negative electrode mixture may contain a binding agent as required. Examples of the binding agent include a thermoplastic resin; specific examples thereof include PVDF, thermoplastic polyimide, carboxymethyl cellulose, polyethylene and polypropylene.

Examples of the negative electrode material capable of being doped and dedoped with a lithium ion include carbonaceous materials such as natural graphite, artificial graphite, coke, carbon black, pyrolytic carbon, carbon fiber and organic polymeric compound burned substance, and chalcogen compounds such as oxides and sulfides for doping and dedoping with a lithium ion at lower electric potential than a positive electrode. The carbonaceous material is preferably a carbonaceous material having graphite materials such as natural graphite and artificial graphite as the main component in that high electric potential flatness and low average discharge electric potential allow high energy density in the case of being combined with the positive electrode.

Cu, Ni and stainless steel may be used as the negative electrode current collector, and Cu is preferable particularly in a lithium secondary battery in view of being hardly made into an alloy with lithium and being easily processed into a thin film. Examples of a method for making the negative electrode current collector support the negative electrode mixture containing the negative electrode material include a method for pressure molding or a method for making into a paste by using a solvent to apply the paste on both sides or one side of the current collector and bond under pressure by pressing after the paste is dried. In the case of applying the paste on the current collector, a paste comprising the negative electrode material, the conductive material, the binding agent, and an organic solvent is used. The organic solvent, the binding agent, and the conductive material to be used may be the one described in the above paste for the positive electrode. Examples of a method for applying include a slit-die coating method, a screen coating method, a curtain coating method, a knife coating method, a gravure coating method and an electrostatic spray coating method.

The positive electrode sheet and the negative electrode sheet each have an electrode tab for performing taking in and out of an electric current. This tab may be string or plate. A part of the positive electrode current collector in the positive electrode sheet and a part of the negative electrode current collector in the negative electrode sheet may be the electrode tab.

The separator is disposed so as to insulate the positive electrode sheet from the negative electrode sheet, isolates the positive electrode sheet from the negative electrode sheet, and prevents electrical short circuit between the electrodes. The use of a separator good in ionic permeability as the separator allows a battery excellent in load characteristic as an important property in a nonaqueous electrolytic solution secondary battery such as a lithium secondary battery. A battery excellent in load characteristic means a battery high in electric capacity taken out upon passing a large electric current.

The separator typically has a porous film containing a thermoplastic resin. In particular, in the case where the device of the present invention is used as a nonaqueous electrolytic solution secondary battery, the separator plays a role of inhibiting (shutting down) an excessive electric current from flowing by intercepting an electric current when an abnormal electric current flows in the battery due to short circuit between the electrodes. Accordingly, the following points are required for the separator; to shut down (block micropores of the porous film) at as low temperature as possible in the case of exceeding ordinary service temperature, and to maintain the shutdown state without rupturing the film due to the high temperature even though the temperature in the battery rises to high temperature to some degree after shutting down, in other words, high heat resistance. The use of a separator comprising a laminated porous film, in which a heat-resistant porous layer containing a heat-resistant resin and a porous film containing a thermoplastic resin are laminated, as the separator allows thermal film rupture of a nonaqueous electrolytic solution secondary battery to be further prevented. The heat-resistant porous layer may be laminated on both sides of the porous film. The thickness of the separator is typically approximately 5 to 20 μm, preferably approximately 5 to 40 μm.

In the separator, the thickness of the porous film containing a thermoplastic resin is typically 3 to 30 μm, more preferably 3 to 20 μm. The porous film has micropores, whose size is typically 3 μm or less, preferably 1 μm or less. The porosity of the porous film is typically 30 to 80% by volume, preferably 40 to 70% by volume. In the case of exceeding ordinary service temperature in a nonaqueous electrolytic solution secondary battery, the porous film blocks micropores by softening of the thermoplastic resin composing the film.

Examples of the thermoplastic resin include a thermoplastic resin which softens at a temperature of 80 to 180° C., and a thermoplastic resin which is not dissolved in the nonaqueous electrolytic solution described later may be selected. Specific examples thereof include polyolefins such as polyethylene and polypropylene, and thermoplastic polyurethane, and a mixture of two kinds or more thereof may be used. The thermoplastic resin is preferably polyethylene for shutting down by softening at a lower temperature. Specific examples of polyethylene include polyethylene such as low-density polyethylene, high-density polyethylene and linear polyethylene, and also ultra-high-molecular-weight polyethylene. In order to further improve the piercing strength of the porous film, the thermoplastic resin preferably contains at least ultra-high-molecular-weight polyethylene. With regard to the production of the porous film, the thermoplastic resin occasionally preferably contains a wax comprising a low-molecular-weight (a weight-average molecular weight of 10000 or less) polyolefin.

The laminated porous film is one in which a heat-resistant porous layer containing a heat-resistant resin is laminated on the porous film. The separator comprising the laminated porous film is described hereinafter. The thickness of the separator is typically 40 μm or less, preferably 20 μm or less. When the thickness of the heat-resistant porous layer and the thickness of the porous film are regarded as T_{A} (μm) and T_{B} (μm) respectively, the value of T_{A}/T_{B} is preferably 0.1 or more and 1 or less. In addition, with regard to this separator, air permeability by the Gurley method is preferably 50 to 300 sec/100 cc, more preferably 50 to 200 sec/100 cc from the viewpoint of ionic permeability. The porosity of this separator is typically 30 to 80% by volume, preferably 40 to 70% by volume.

In the laminated porous film, the heat-resistant porous layer contains a heat-resistant resin. In order to further improve ionic permeability, the heat-resistant porous layer preferably has a thickness as thin as 1 μm or more and 10 μm or less, further 1 μm or more and 5 μm or less, particularly 1 μm or more and 4 μm or less. The heat-resistant porous layer has micropores, whose size (diameter) is typically 3 μm or less, preferably 1 μm or less. In addition, the heat-resistant porous layer may also contain the filler described later.

Examples of the heat-resistant resin contained in the heat-resistant porous layer include polyamide, polyimide, polyamideimide, polycarbonate, polyacetal, polysulfone, polyphenylsulfide, polyether ether ketone, aromatic polyester, polyether sulfone and polyether imide; from the viewpoint of further improving heat resistance, preferably polyamide, polyimide, polyamideimide, polyether sulfone and polyether imide, more preferably polyamide, polyimide and polyamideimide. The heat-resistant resin is further more preferably nitrogen-containing aromatic polymers such as aromatic polyamide (para oriented aromatic polyamide and meta oriented aromatic polyamide), aromatic polyimide and aromatic polyamideimide, especially preferably aromatic polyamide, and particularly preferably para oriented aromatic polyamide (occasionally referred to as “para aramide” hereinafter) in view of production. Also, examples of the heat-resistant resin include poly-4-methylpentene-1 and a cyclic olefin polymer. The use of these heat-resistant resins allows heat resistance to be improved, namely, thermal film rupture temperature to be increased.

The thermal film rupture temperature depends on the kind of the heat-resistant resin and is typically 160° C. or more. The use of the nitrogen-containing aromatic polymers as the heat-resistant resin allows the thermal film rupture temperature to be raised up to approximately 400° C. at the maximum. The thermal film rupture temperature may be raised up to approximately 250° C. and 300° C. at the maximum in the case of using poly-4-methylpentene-1 and a cyclic olefin polymer, respectively.

The para aramide is obtained by condensation polymerization of para oriented aromatic diamine and para oriented aromatic dicarboxylic halide, and consists essentially of a repeating unit in which the amide bond is bonded in the para-position or orientation position in accordance therewith of the aromatic ring (orientation position coaxial or parallel in opposite directions, such as 4,4′-biphenylene, 1,5-naphthalene and 2,6-naphthalene). Examples of the para aramide include para aramide having para orientation or a structure in accordance with para orientation; specifically, poly(paraphenyleneterephthalamide), poly(parabenzamide), poly(4,4′-benzanilideterephthalamide), poly(paraphenylene-4,41-biphenylenedicarboxylicamide), poly(paraphenylene-2,6-naphthalenedicarboxylicamide), poly(2-chloro-paraphenyleneterephthalamide) and a paraphenyleneterephthalamide/2,6-dichloroparaphenyleneterephthalamide copolymer.

The aromatic polyimide is preferably wholly aromatic polyimide produced by condensation polymerization of aromatic diacid anhydride and diamine. Specific examples of the diacid anhydride include pyromellitic dianhydride, 3,3′,4,4′-diphenyl sulfone tetracarboxylic dianhydride, 3,3′,4,41-benzophenone tetracarboxylic dianhydride, 2,2′-bis(3,4-dicarboxyphenyl)hexafluoropropane and 3,3′,4,4′-biphenyl tetracarboxylic dianhydride. Examples of the diamine include oxydianiline, para-phenylenediamine, benzophenonediamine, 3,3′-methylenedianiline, 3,3′-diaminobenzophenone, 3,3′-diaminodiphenyl sulfone and 1,5′-naphthalenediamine. Polyimide soluble in a solvent may be suitably used. Examples of such polyimide include polyimide as a polycondensate of 3,3′,4,4′-diphenyl sulfone tetracarboxylic dianhydride and aromatic diamine.

Examples of the aromatic polyamideimide include a product obtained from condensation polymerization of aromatic dicarboxylic acid and aromatic diisocyanate, and a product obtained from condensation polymerization of aromatic diacid anhydride and aromatic diisocyanate. Specific examples of the aromatic dicarboxylic acid include isophthalic acid and terephthalic acid. Specific examples of the aromatic diacid anhydride include trimellitic anhydride. Specific examples of the aromatic diisocyanate include 4,4′-diphenylmethane diisocyanate, 2,4-tolylene diisocyanate, 2,6-tolylene diisocyanate, ortho-trilandiisocyanate and meta-xylylene diisocyanate.

The filler optionally contained in the heat-resistant porous layer may be selected from an organic powder, an inorganic powder and a mixture thereof. With regard to particles composing the filler, the average particle diameter thereof is preferably 0.01 μm or more and 1 μm or less. Examples of the shape of the filler include an approximately spherical shape, a tabular shape, a columnar shape, an acicular shape, a whiskery shape and a fibrous shape, and particles having any of the above shapes may be used; approximately spherical particles are preferable by reason of easily forming uniform pores.

Examples of the organic powder as the filler include a powder comprising organic matters such as one or a copolymer of two kinds or more of styrene, vinyl ketone, acrylonitrile, methyl methacrylate, ethyl methacrylate, glycidyl methacrylate, glycidyl acrylate and methyl acrylate; fluororesins such as polytetrafluoroethylene, a tetrafluoroethylene-hexafluoropropylene copolymer, a tetrafluoroethylene-ethylene copolymer and polyvinylidene fluoride; a melamine resin; a urea resin; a polyolefin; and polymethacrylate. The organic powder may be used singly or by mixing two kinds or more. Among these organic powders, a polytetrafluoroethylene powder is preferable in view of chemical stability.

Examples of the inorganic powder as the filler include a powder comprising inorganic matters such as metal oxides, metal nitrides, metal carbides, metal hydroxides, carbonates and sulfates; and specific examples thereof include a powder comprising alumina, silica, titanium dioxide or calcium carbonate. The inorganic powder may be used singly or by mixing two kinds or more. Among these inorganic powders, an alumina powder is preferable in view of chemical stability. It is more preferable that all of the particles composing the filler are alumina particles, and it is further more preferable that all of the particles composing the filler are alumina particles and a part or all thereof are approximately spherical alumina particles.

The content of the filler in the heat-resistant porous layer depends also on the specific gravity of the material for the filler; for example, in the case where all of the particles composing the filler are alumina particles, the mass of the filler is typically 20 or more and 95 or less, preferably 30 or more and 90 or less when the total mass of the heat-resistant porous layer is regarded as 100. These ranges may be properly determined depending on the specific gravity of the material for the filler.

An electrode group comprising the positive electrode sheet, the negative electrode sheet, and the separator disposed so as to insulate the positive electrode sheet from the negative electrode sheet (occasionally referred to as “the positive electrode, the negative electrode, and the separator” hereinafter) may be produced by winding the positive electrode, the negative electrode, and the separator. This electrode group obtained by winding the positive electrode, the negative electrode, and the separator is a preferable embodiment in view of ease of production and ease of improvement of electrode density. Then, the electrode group completely wound is preferably fixed by a tape so that the winding does not loosen. Except for this electrode group obtained by winding, three sheets of the positive electrode, the negative electrode, and the separator may be superposed in zigzags into an electrode group, or the three sheets may be laminated into an electrode group.

A plurality of such electrode groups are included in a single vessel to obtain the device of the present invention. Proper connection of these plural electrode groups allows a single device capable of easily modifying the capacity, and does not require separate preparation of is electrode groups with number of turns or number of laminations different in accordance with the capacity. This device is formed as a single device, so that space saving is achieved as compared with the conventional case of using a plurality of devices. In addition, a single device allows temperature difference in the device to be further decreased, and thus the performance of the device may be sufficiently brought out.

In the device of the present invention, a material capable of ionic conduction is further contained in the vessel and the material may be shared among the plurality of electrode groups. The material is mainly shared while contained in the separator of each of the plurality of electrode groups. The separator with desirable dielectric performance or electrical conductivity may be obtained in accordance with ionic conductivity of the material. Then, the material is shared among the plurality of electrode groups, so that temperature difference in the vessel may be further decreased, and thus the performance of the device may be sufficiently brought out. In particular, this device is appropriately used as a battery.

A material capable of conduction of a lithium ion and/or a sodium ion may be used for the material capable of ionic conduction. Examples of the material capable of conduction of a lithium ion include a nonaqueous electrolytic solution in which a lithium salt is dissolved in an organic solvent, and examples of the material capable of conduction of a sodium ion include a nonaqueous electrolytic solution in which a sodium salt is dissolved in an organic solvent. The use of these nonaqueous electrolytic solutions as the material capable of ionic conduction allows the device of the present invention to be preferably used as a nonaqueous electrolytic solution secondary battery.

Examples of the lithium salt include one kind or a mixture of two kinds or more among LiClO₄, LiPF₆, LiAsF₆, LiSbF₆, LiBF₄, LiCF₃SO₃, LiN(SO₂CF₃)₂, LiC(SO₂CF₃)₃, Li₂B₁₀Cl₁₀, lithium lower aliphatic carboxylate and LiAlCl₄. Among these, a lithium salt including at least one kind selected from the group consisting of LiPF₆, LiAsF₆, LiSbF₆, LiBF₄, LiCF₃SO₃, LiN(CF₃SO₂)₂ and LiC(CF₃SO₂)₃ containing fluorine is preferably used as the lithium salt. A sodium salt in which Li in the lithium salt is substituted with Na may be used as the sodium salt.

Examples of the organic solvent used in the nonaqueous electrolytic solution include carbonates such as propylene carbonate, ethylene carbonate, dimethyl carbonate, diethyl carbonate, ethyl methyl carbonate, 4-trifluoromethyl-1,3-dioxolane-2-one and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran and 2-methyltetrahydrofuran; esters such as methyl formate, methyl acetate and γ-butyrolactone; nitrites such as acetonitrile and butyronitrile; amide compounds such as N,N-dimethylformamide and N,N-dimethylacetamide; carbamates such as 3-methyl-2-oxazolidone; sulfur-containing compounds such as sulfolane, dimethyl sulfoxide and 1,3-propanesultone; or an organic solvent obtained by introducing a fluorine substituent into the above organic solvent: and two kinds or more among these may be used by mixing them with each other.

Among these, a mixed solvent containing a carbonate is preferable, and a mixed solvent of a cyclic carbonate and an acyclic carbonate or a mixed solvent of a cyclic carbonate and an ether are more preferable. The mixed solvent of a cyclic carbonate and an acyclic carbonate is preferably a mixed solvent containing ethylene carbonate, dimethyl carbonate and ethyl methyl carbonate in view of offering a wide operating temperature range, an excellent load characteristic, and persistency even in the case of using graphite materials such as natural graphite and artificial graphite as the negative electrode material.

The single vessel including the plurality of electrode groups may be any vessel such as a metal can and a resin can, or particularly made of a laminated film unless the component inside the vessel, such as the material capable of ionic conduction (for example, the nonaqueous electrolytic solution), leaks. The space capacity of the vessel made of a laminated film is small as compared with other general vessels, and thus the space may be effectively utilized.

The shape of the device of the present invention is not particularly limited and may be any of a paper shape, a coin shape, a cylindrical shape and a square shape, and the electrode group is formed into a predetermined shape in accordance with these shapes of the device.

In the present invention, all of the electrode tabs of the positive electrode sheet and the negative electrode sheet may be taken outside the vessel. In this case, the takeout direction of the electrode tabs to the outside may be any direction. The connection of the electrode tabs outside the device may be freely selected, and the connection in series or in parallel allows the device capable of easily obtaining an optional voltage and an optional capacity. At least two of the electrode groups among the plurality of electrode groups may be connected in series or in parallel inside the vessel by connection of the electrode tabs of each of the electrode groups. In the plurality of electrode groups, the electrode tabs of the positive electrode sheet are connected and the electrode tabs of the negative electrode sheet are connected (connected in parallel), so that the capacity is easily controlled than in conventional cases (where it is necessary to obtain the device by separately preparing electrode groups with different number of turns or different number of laminations in accordance with the capacity); and the electrode tabs of the positive electrode sheet in one electrode group and the electrode tabs of the negative electrode sheet in another electrode group are connected and thus the electrode groups are connected (connected in series), so that the voltage is easily controlled than in conventional cases (where it is occasionally necessary to connect and combine plural devices in series for obtaining an optional voltage). The device comprising a single vessel may be used as a single device having two or more device functions by switching the connection of the electrode tabs. Thus, the present invention allows the device having a high degree of freedom to be utilized.

The device may be used as a storage device. Examples of the storage device include a battery such as a nonaqueous electrolytic solution secondary battery, a condenser and a capacitor.

In particular, in the case of further including a material capable of ionic conduction in the vessel, the device of the present invention is a storage device in which ions come and go between the positive electrode sheet and the negative electrode sheet, particularly, a secondary battery. In addition, the material capable of ionic conduction may be a nonaqueous electrolytic solution, in which case the device of the present invention is used as a nonaqueous electrolytic solution secondary battery.

### EXAMPLES

A battery having two electrode groups is described as an example of the embodiment of the present invention. However, the present invention is not limited to this embodiment and may comprise three or more electrode groups. Also, the present invention may be a condenser or a capacitor, and known techniques may be applied thereto as required.

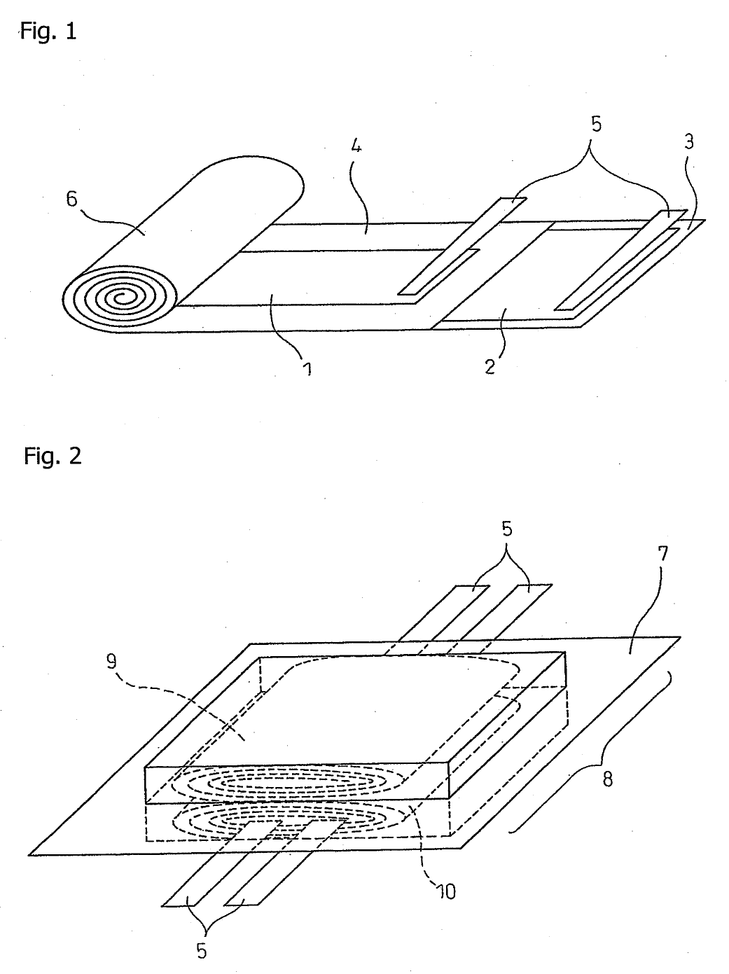

As shown in FIG. 1, a separator 3 comprising a porous polyethylene sheet, a negative electrode sheet 2 produced by applying graphite on both sides of Cu foil, a positive electrode sheet 1 produced by applying an oxide containing Li on both sides of Al foil, and a separator 4 comprising a porous polyethylene sheet were sequentially laminated and arranged so as to insulate the positive electrode sheet from the negative electrode sheet upon winding. This laminate was wound into a flat shape to produce an electrode group 6. The electrode group completely wound was fixed by a tape so that the winding would not loosen. An electrode tab 5 for performing taking in and out of an electric current was welded to the positive electrode sheet 1 and the negative electrode sheet 2. Another electrode group 6 was produced in the same manner.

The two electrode groups 6 were inserted into the vessel of a laminated film 7 so that each of the electrode tabs 5 taken outside on the opposite side to each other (refer to FIG. 2), and then three sides thereof were sealed.

An electrolytic solution was injected through one unsealed side into the vessel of the laminated film with the electrode groups inserted, and preserved for a whole day and night to impregnate the separator with the electrolytic solution. After impregnating, the excessive electrolytic solution was extracted. Thereafter, the one side was sealed while decompressed so as to cause no voids inside the vessel. Thus, a laminate battery as an example of the present invention shown in FIG. 2 was produced.

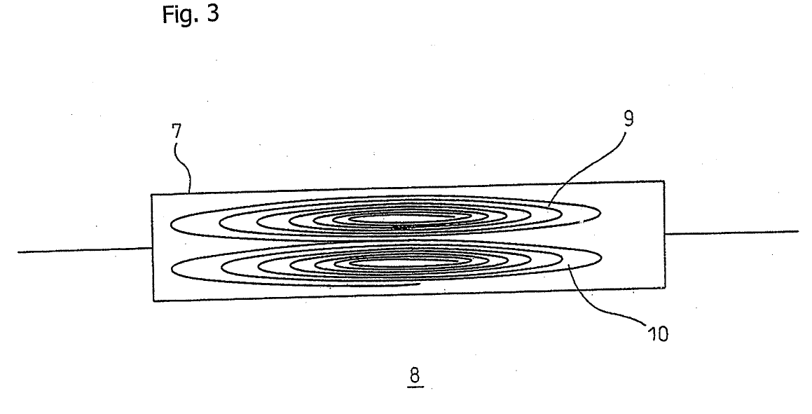

A schematic cross-sectional view of the laminate battery produced in the above manner is shown in FIG. 3. Two electrode groups each in 10 cm square were used in this example. In the example, the electrode tab of each of the electrode groups was taken outside of the opposite side of the vessel of the laminated film. The connection in series and in parallel of the tabs taken outside allows the voltage and the capacity to be adjusted respectively. Each of the electrode groups may be handled as an independent battery.

Two electrode groups were used in the example of the present invention and the electrode tab of each of the electrode groups was taken outside of the opposite side of the vessel of the laminated film. However, the present invention is not limited to this embodiment; any number of the electrode groups may be used as long as a plurality of the electrode groups are used, and the takeout direction of the electrode tab may be any direction. In addition, the electrode tabs may be connected inside the vessel. The battery vessel is not limited to a laminate but may be any vessel such as a metal can and a resin can unless the electrolytic solution leaks. The shape of the vessel may be any shape such as a cylinder and a cube. The electrode groups are occasionally partitioned with an insulating film.

### Production Example

### Production of Laminated Porous Film

### (1) Production of Coating Liquid for Heat-Resistant Layer

272.7 g of calcium chloride was dissolved in 4200 g of N-methyl-2-pyrrolidone (NMP), and thereafter 132.9 g of paraphenylene diamine was added thereto and completely dissolved. 243.3 g of terephthaloyl dichloride was gradually added to the obtained solution and polymerized to obtain para aramide, which was further diluted with NMP to obtain a para aramide solution with a concentration of 2.0% by mass. 2 g of a first alumina powder (Alumina C, manufactured by Japan Aerosil, having an average particle diameter of 0.02 μm) and 2 g of a second alumina powder (SUMICORUNDUM AA03, manufactured by Sumitomo Chemical Co., Ltd., having an average particle diameter of 0.3 μm) were added and mixed as a filler by 4 g in total into 100 g of the obtained para aramide solution, treated with a nanomizer three times, further filtered with a wire gauze of 1000 mesh, and defoamed under reduced pressure to produce slurry coating liquid for a heat-resistant layer. The mass of the alumina powder (the filler) with respect to the total mass of para aramide and the alumina powder is 67% by mass.

### (2) Production of Laminated Porous Film

A porous film made of polyethylene (having a film thickness of 12 μm, an air permeability of 140 sec/100 cc, an average pore diameter of 0.1 μm and a porosity of 50%) was used as the porous film containing a thermoplastic resin. The porous film made of polyethylene was fixed on a PET film with a thickness of 100 μm and coated with the slurry coating liquid for a heat-resistant layer by a bar coater manufactured by TESTER SANGYO CO., LTD. The coated porous film on the PET film was immersed in water as a poor solvent while being integrated to precipitate the para aramide porous film (the heat-resistant layer) and thereafter the solvent was dried to obtain a laminated porous film in which the heat-resistant layer and the porous film were laminated.

### (3) Evaluation of Laminated Porous Film

The thickness of the laminated porous film was 16 μm and the thickness of the para aramide porous film (the heat-resistant layer) was 4 μm. The air permeability of the laminated porous film was 180 sec/100 cc and the porosity thereof was 50%. When the cross section of the heat-resistant layer in the laminated porous film was observed by a scanning electron microscope (SEM), it was found that the heat-resistant layer had comparatively small micropores of approximately 0.03 μm to 0.06 μm and comparatively large micropores of approximately 0.1 μm to 1 μm.

The evaluation of the laminated porous film was performed in accordance with the following (A) to (C).

(A) Thickness Measurement

The thickness of the laminated porous film and the thickness of the porous film were measured in accordance with a JIS standard (K7130-1992). The value obtained by subtracting the thickness of the porous film from the thickness of the laminated porous film was used as the thickness of the heat-resistant layer.

(B) Measurement of Air Permeability by the Gurley Method

The air permeability of the laminated porous film was measured by a Gurley densometer of digital timer type manufactured by YASUDA SEIKI SEISAKUSHO, LTD. in accordance with JIS P8117.

(C) Porosity

A sample of the obtained laminated porous film was cut into a square with a side of 10 cm to measure the mass W (g) and the thickness D (cm) thereof. The mass (Wi) of each layer in the sample was measured, and the volume of each layer was calculated from Wi and the true specific gravity (g/cm³) of the material for each layer to calculate the porosity (% by volume) from the following expression.

Porosity (% by volume)=100×{1−(W1/true specific gravity 1+W2/true specific gravity 2+ . . . +Wn/true specific gravity n)/(10×10×D)}

In the example, the use of the laminated porous film obtained by the Production Example as the separator gives a battery capable of further preventing thermal film rupture.

What is claimed is:

1. A device wherein a plurality of electrode groups each comprising a positive electrode sheet having an electrode tab, a negative electrode sheet having an electrode tab, and a separator disposed so as to insulate the positive electrode sheet from the negative electrode sheet, are included in a single vessel.

2. The device according to claim 1, wherein a plurality of electrode groups each obtained by winding a positive electrode sheet having an electrode tab, a negative electrode sheet having an electrode tab, and a separator disposed so as to insulate the positive electrode sheet from the negative electrode sheet, are included in a single vessel.

3. The device according to claim 1, wherein the vessel is made of a laminated film.

4. The device according to claim 1, wherein all of the electrode tabs are taken outside the vessel.

5. The device according to claim 1, wherein at least two of the electrode groups among the plurality of electrode groups are connected in series or in parallel inside the vessel by connection of the electrode tab of each of the electrode groups.

6. The device according to claim 1, being used as a storage device.

7. The device according to claim 1, further comprising
a material capable of ionic conduction in the vessel,
wherein the material is shared among the plurality of electrode groups.

8. The device according to claim 7, wherein the material is a material capable of conduction of a lithium ion and/or a sodium ion.

9. The device according to claim 7, being used as a battery.

10. The device according to claim 7, wherein the material is a nonaqueous electrolytic solution.

11. The device according to claim 7, being used as a nonaqueous electrolytic solution secondary battery.
